(19) United States
(12) Patent Application Publication
(10) Pub. No.: US 2025/0368192 A1
(43) Pub. Date: Dec. 4, 2025

(54) COLLISION AVOIDANCE BY OBSERVED VEHICLE WHEEL ROTATION

(71) Applicant: Volvo Car Corporation, Göteborg (SE)

(72) Inventors: Marcus Maxvall, Göteborg (SE); Filip Nielsen, Göteborg (SE); Mikael Törmänen, Göteborg (SE); Karolina Landin, Göteborg (SE)

(21) Appl. No.: 18/679,588

(22) Filed: May 31, 2024

(51) Int. Cl. B60W 30/09; B60W 30/095; B60W 50/14

(52) U.S. Cl. CPC B60W 30/09; B60W 30/0956; B60W 50/14; B60W 2050/146; B60W 2554/404

(57) ABSTRACT

A method for avoiding vehicle collisions. The method includes capturing data on an external environment using at least one perception coupled to an ego vehicle. The method further includes detecting at least one wheel of at least one object vehicle based on the data that is captured. The method further includes computing wheel movement information of the at least one wheel, wherein the wheel movement information indicates vehicle movement information of the at least one object vehicle. The method further includes detecting a predicted collision between the ego vehicle and the at least one object vehicle based on the wheel movement information.

### INTRODUCTION

The present disclosure relates generally to the automotive field. Some vehicles have capabilities to avoid collisions with other vehicles on the road. For example, a vehicle may automatically slow down if the vehicle gets too close to another vehicle up ahead in the same lane. A vehicle may sound a warning to the driver if the vehicle veers off of the current lane. However, conventional methods of collision avoidance are limited to location and speed assessment, which thereby limits a vehicles ability to avoid some potential collisions.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for avoiding vehicle collisions. As described in more detail herein, embodiments enable a system of an ego vehicle to detect and identify potential collisions between the ego vehicle and surrounding object vehicles traveling on the same street or road. Embodiments also provide alerts to the driver of the ego vehicle and to drivers of other surrounding object vehicles to aid in avoiding a predicted collision. Embodiments also enable the ego vehicle to perform one or more evasive actions to avoid the predicted collision.

In one illustrative embodiment, the present disclosure provides an ego vehicle including at least one perception sensor positioned on an exterior portion of or disposed within the ego vehicle; and a system including one or more processors and logic encoded in one or more non-transitory computer-readable storage media for execution by the one or more processors. The logic when executed is operable to cause the one or more processors to perform operations including: capturing data on an external environment using the at least one perception sensor; detecting at least one wheel of at least one object vehicle based on the data that is captured; computing wheel movement information of the at least one wheel, where the wheel movement information indicates vehicle movement information of the at least one object vehicle; and detecting a predicted collision between the ego vehicle and the at least one object vehicle based on the wheel movement information. Optionally, in some embodiments, the wheel information includes wheel rotation information. In some embodiments, the logic when executed is further operable to cause the one or more processors to perform operations including alerting a driver of the ego vehicle of the predicted collision based on the wheel information. In some embodiments, the logic when executed is further operable to cause the one or more processors to perform operations including alerting a driver of the ego vehicle of the predicted collision via an infotainment system of the ego vehicle. In some embodiments, the logic when executed is further operable to cause the one or more processors to perform operations including alerting at least one other driver of the at least one object vehicle of the predicted collision via crowdsourcing. In some embodiments, the logic when executed is further operable to cause the one or more processors to perform operations including performing one or more evasive actions of the ego vehicle to avoid the predicted collision. In some embodiments, the logic when executed is further operable to cause the one or more processors to perform operations including performing one or more evasive actions to avoid the predicted collision, where at least one evasive action of the one or more evasive actions includes alerting a traffic infrastructure system of the predicted collision.

In a further illustrative embodiment, the present disclosure provides a non-transitory computer-readable storage medium with program instructions stored thereon. The program instructions when executed by one or more processors are operable to cause the one or more processors to perform operations including: capturing data on an external environment using at least one perception sensor positioned on an exterior portion of or disposed within an ego vehicle; detecting at least one wheel of at least one object vehicle based on the data that is captured; computing wheel movement information of the at least one wheel, where the wheel movement information indicates vehicle movement information of the at least one object vehicle; and detecting a predicted collision between the ego vehicle and the at least one object vehicle based on the wheel movement information. Optionally, in some embodiments, the wheel information includes wheel rotation information. In some embodiments, the instructions when executed are further operable to cause the one or more processors to perform operations including alerting a driver of the ego vehicle of the predicted collision based on the wheel information. In some embodiments, the instructions when executed are further operable to cause the one or more processors to perform operations including alerting a driver of the ego vehicle of the predicted collision via an infotainment system of the ego vehicle. In some embodiments, the instructions when executed are further operable to cause the one or more processors to perform operations including alerting at least one other driver of the at least one object vehicle of the predicted collision via crowdsourcing. In some embodiments, the instructions when executed are further operable to cause the one or more processors to perform operations including performing one or more evasive actions of the ego vehicle to avoid the predicted collision. In some embodiments, the instructions when executed are further operable to cause the one or more processors to perform operations including performing one or more evasive actions to avoid the predicted collision, where at least one evasive action of the one or more evasive actions includes alerting a traffic infrastructure system of the predicted collision.

In a further illustrative embodiment, the present disclosure provides a computer-implemented method for avoiding vehicle collisions. The method includes: capturing data on an external environment using at least one perception sensor positioned on an exterior portion of or disposed within an ego vehicle; detecting at least one wheel of at least one object vehicle based on the data that is captured; computing wheel movement information of the at least one wheel, where the wheel movement information indicates vehicle movement information of the at least one object vehicle; and detecting a predicted collision between the ego vehicle and the at least one object vehicle based on the wheel movement information. Optionally, in some embodiments, the wheel information includes wheel rotation information. In some embodiments, the method further includes alerting a driver of the ego vehicle of the predicted collision based on the wheel information. In some embodiments, the method further includes alerting a driver of the ego vehicle of the predicted collision via an infotainment system of the ego vehicle. In some embodiments, the method further includes alerting at least one other driver of the at least one object vehicle of the predicted collision via crowdsourcing. In some embodiments, the method further includes performing one or more evasive actions of the ego vehicle to avoid the predicted collision.

### BRIEF DESCRIPTION OF THE DRAWINGS

The present disclosure is illustrated and described with reference to the various drawings, in which like reference numbers are used to denote like assembly and/or system components and/or method steps, as appropriate.

FIG. 1 is a top-view block diagram of an example environment including an ego vehicle and surrounding object vehicles.

FIG. 2 is a side-view block diagram of an example environment including an ego vehicle and a surrounding object vehicle.

FIG. 3 is a flow chart for avoiding vehicle collisions.

FIG. 4 is a side-view image of an environment including a wheel of an object vehicle.

FIG. 5 is a flow chart for alerting the driver of an ego vehicle of a predicted collision.

FIG. 6 is a block diagram of an environment, showing a perspective toward the front of a vehicle.

FIG. 7 is a flow chart for alerting drivers of surrounding object vehicles of a predicted collision and for performing evasive actions to avoid the vehicle collision.

FIG. 8 is a block diagram of an example high-level architecture for avoiding vehicle collisions.

FIG. 9 is a block diagram of an example network environment of the present disclosure.

FIG. 10 is a block diagram of an example computing system of the present disclosure.

### DETAILED DESCRIPTION

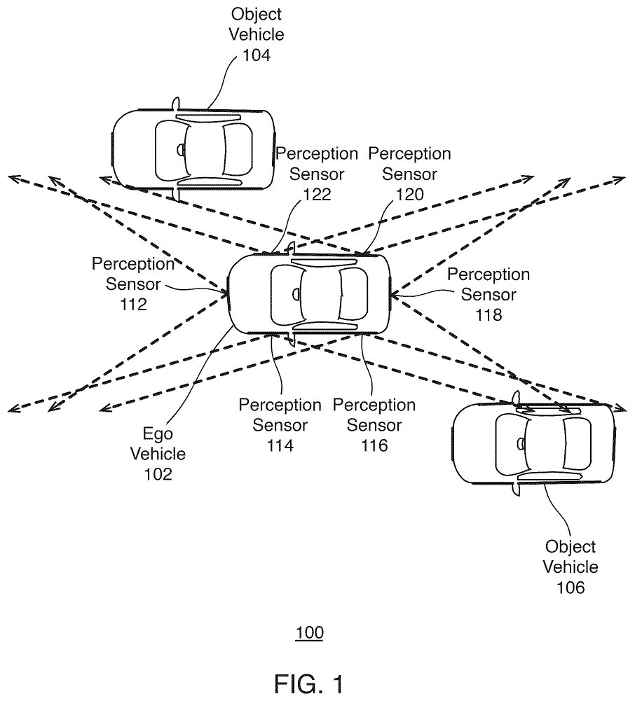

FIG. 1 is a top-view block diagram of an example environment 100 including an ego vehicle and surrounding object vehicles. Shown is an ego vehicle 102 traveling on a road and surrounding object vehicles 104 and 106 that are traveling in the same direction as the ego vehicle 102. The ego vehicle 102 has perception sensors positioned at various locations on the exterior of or disposed within the vehicle 102. The terms ego vehicle 102 and vehicle 102 may be used interchangeably.

As shown, a perception sensor 114 is positioned at the front of the vehicle 102 (e.g., on the bumper or grill). A perception sensor 114 is positioned at the front left side of the vehicle 102. Another perception sensor 116 is also positioned at the rear left side of the vehicle 202. A perception sensor 118 is positioned at the rear of the vehicle 102 (e.g., on the bumper or above the bumper). A perception sensor 122 is positioned at the front right side of the vehicle 102. A perception sensor 120 is positioned at the rear right side of the vehicle 102.

Being positioned on or at the exterior portion of the ego vehicle 102 means that at least one portion of a perception sensor such as a lens is exposed to the environment 100, or external environment 100. In various embodiments, one or more perception sensors may be positioned at interior portions of the vehicle. For example, one or more of the perception sensors may be positioned inside the vehicle with views through one or more windows (e.g., behind the front windshield, near the rear-view mirror, etc.). As such, the perception sensors capture various types vantage points as well as various types of data associated with the external environment 100.

The actual number of perception sensors positioned on the exterior of the vehicle 102 or in the interior the vehicle 102 may vary, depending on the particular implementation. Also, the positions or locations of the perception sensors on the vehicle 102 may vary, depending on the particular implementation. For example, one or more perception sensors maybe positioned or mounted on the roof of the vehicle 102, underneath the vehicle 102, etc.

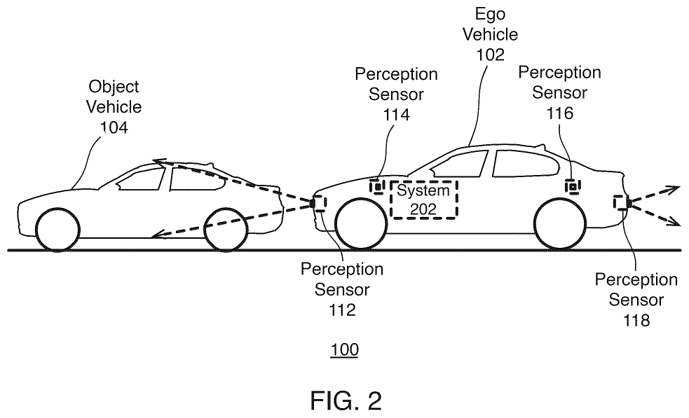

As indicated by the dotted arrows associated with the perception sensors 112, 114, 116, 118, 120, and 122, these perception sensors function to capture data on the surrounding external environment 100, including the surrounding object vehicles such as object vehicles 104 and 106. Such data may also include other objects such as people, etc., as well as weather elements such as rain, snow, etc. Further embodiments directed to the vehicle 102 and its perception sensors are described in more detail herein, in connection with FIG. 2, for example.

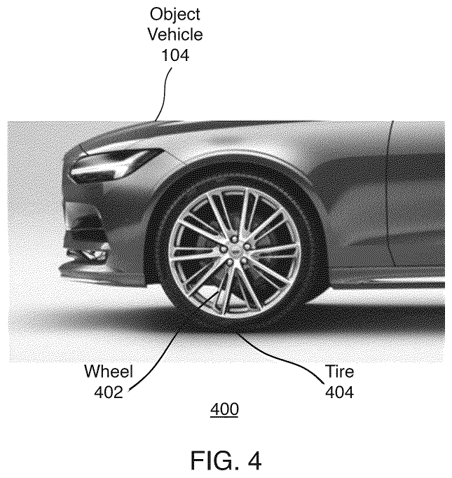

FIG. 2 is a side-view block diagram of the example environment 100 including the ego vehicle 102 and the object vehicle 104 of FIG. 1. The object vehicle 104 is traveling just ahead of the ego vehicle 102 on the lane to the right of the ego vehicle 102, as shown in FIG. 1. As described in more detail herein, a system 202 of the ego vehicle 102 utilizes the perception sensors of the ego vehicle 102 to capture data on the external environment, including the surrounding object vehicles such as object vehicle 104. For ease of illustration, only object vehicle 104 is shown. As described in more detail below, the system 202 utilizes its perception sensors to detect one or more wheels of one or more of the surrounding object vehicles such as the object vehicle 104 based on the data that is captured by the perception sensors. Example embodiments directed to the detection of wheels and predictions of vehicle collisions based on wheels are described in more detail below, in connection with FIG. 4, for example.

In various embodiments, the system 202 may utilize multiple types of perception sensors to capture data on the external environment 100. Any sensing methodology may be used, and the particular sensing methodology will depend on the particular implementation. For example, in various embodiments, one or more perception sensors may include one or more image sensing perception sensors or cameras, radar detectors, light detection and ranging (Lidar) cameras, and/or ultrasonic cameras, or any combination thereof. The system may utilize image sensing perception sensors or cameras and/or infrared (IR) perception sensors or cameras and/or radar perception sensors or cameras.

Various perception sensors are described herein in the context of image sensing perception sensors such as cameras, etc., to assist the driver while driving. In various embodiments, the system may utilize any one or more of these perception sensors and/or other types of sensors and cameras to collect data described herein. For example, such collected data may include data on any objects outside of the vehicle 102, including objects on the road. For example, such objects may include road surface features (e.g., bumps, potholes, etc.), environmental features (e.g., trash, alive or dead animals, rocks, boulders, etc.). Such objects may also include other vehicles or people. The data may include Lidar data and well as images. The images may be a continuous series of images, which may include video.

In various embodiments, the perception sensors 112, 114, 116, 118, 120, and 122, of the vehicle 102 may be referred to as client devices, which may communicate with the system 202. Such communications may be facilitated via any suitable communication network (not shown) such as a wired network, a Bluetooth network, a Wi-Fi network, etc., or any combination thereof.

For ease of illustration, FIG. 2 shows one block for each of the system 202 and the perception sensors 112, 114, 116, and 118. Each of these blocks may represent multiple systems and perception sensors. In other implementations, environment 100 may not have all of the components shown and/or may have other elements including other types of elements instead of, or in addition to, those shown herein.

While the system 202 performs implementations described herein, in other implementations, any suitable component or combination of components associated with the system 202 or any suitable processor or processors associated with the system 202 may facilitate performing the implementations described herein.

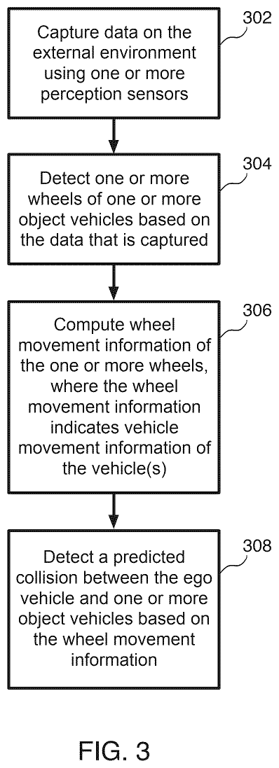

FIG. 3 is a flow chart for avoiding vehicle collisions. Referring to both FIGS. 1, 2, and 3, a method is initiated at block 302, where a system such as the system 202 captures data on the external environment using one or more perception sensors positioned on the exterior portion of or disposed within the ego vehicle 102. For example, as shown in FIG. 1, the perception sensors 112, 114, 116, 118, 120, and 122 are disposed or situated around the ego vehicle 102. This enables system 202 to collect data on the surrounding external environment, including collecting data captured in association with surrounding object vehicles, such as object vehicles 104 and 106.

At block 304, the system 202 detects at least one wheel of at least one object vehicle in the external environment based on the data that is captured. For example, referring to FIGS. 1 and 2, the perception sensors 112, 114, 116, 118, 120, and 122 of the ego vehicle 102 capture data including images surrounding the ego vehicle 102. In the examples shown, the front left wheel of the object vehicle 104 is in the field of view of perception sensors 120 and 122. If the object vehicle 104 where to speed up and away from the ego vehicle 102, that front left wheel of the object vehicle 104 would at least momentarily be in the field of view of both the perception sensors 122 and 112. If the object vehicle 104 where to speed up and away from the ego vehicle 102 even more, that front left wheel of the object vehicle 104 would at least momentarily be in the field of view of at least the perception sensor 112. As such, the perception sensors of the ego vehicle 102 detect the front left wheel of the object vehicle 104 at different moments based on the vehicles' relative positions and based on data that is captured by the perception sensors.

In various embodiments, the system 202 collects data on the surrounding external environment, including data associated with any one more wheels of a given surrounding object vehicle. The example above considers the front left wheel of the object vehicle 104. Similar detection of the rear left wheel of the object vehicle 104 as well as the front right wheel and the rear right wheel of the object vehicle 106 may apply in the examples shown in FIGS. 1 and 2.

At block 306, the system 202 computes wheel movement information of any wheel or wheels captured by the perception sensors. As described in more detail herein, the system 202 analyzes the wheel movement to compute various characteristics of the wheel movement (e.g., speed, acceleration, deceleration, direction, etc.). In various embodiments, the wheel movement information indicates corresponding vehicle movement information of the corresponding object vehicle. For example, if a wheel of the object vehicle 104 is accelerating in rotation, the object vehicle 104 is also accelerating. If a wheel of the object vehicle 104 is decelerating in rotation, the object vehicle 104 is also decelerating. Example embodiments directed to the wheel movement information and associated vehicle movement information are described in more detail below, in connection with FIG. 4, for example.

At block 308, the system 202 detects a predicted collision between the ego vehicle and any of the surrounding object vehicles such as object vehicle 104 based on wheel movement information. For example, if a wheel of a surrounding object vehicle such as object vehicle 104 is turning toward the ego vehicle 102, this indicates that the object vehicle is turning toward the ego vehicle 102. The system 202 may deem this to be a predicted collision between the object vehicle in question and the ego vehicle 102.

Some embodiments are described herein in the context of an incoming object vehicle such as the object vehicle 104 that is about collide with the ego vehicle 102, where the object vehicle 104 is traveling in the same direction as the ego vehicle 102. These embodiments also apply to other scenarios where an incoming object vehicle is going to collied with the ego vehicle 102. For example, the incoming object vehicle may be approaching the same intersection as the ego vehicle 102, where the incoming object vehicle is traveling on a perpendicular path to the path of the ego vehicle 102. In this scenario, the incoming object vehicle is not slowing down for a red light and is about to run the red light, and is thereby about to collide into the ego vehicle 102. In other example scenarios, an incoming object vehicle may be pulling out of another street or out of a parking lot or out of a parking slot of a parking lot or out of a parking spot from the side of the street and into the path of the ego vehicle 102. Example embodiments directed to predicting collisions are described in more detail below, in connection with FIG. 4, for example.

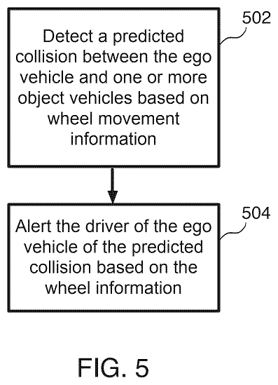

As described in more detail below, in connection with FIG. 5, the system 202 may communicate information such as collision alerts on predicted collisions to the driver of the ego vehicle 102 via an infotainment system of the vehicle 102. Such information may be conveyed visually and/or auditorily by the infotainment system of the vehicle 102, depending on the particular implementation.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 4 is a side-view image of an environment 400 including a wheel of the object vehicle 104 of FIGS. 1 and 2. For ease of illustration, a portion of the object vehicle 104 is shown to highlight a wheel 402 including a tire 404. The following descriptions may apply to other wheels of the object vehicle 104 and/or other wheels of other surrounding object vehicles that are captured by the perception sensors 112, 114, 116, 118, 120, and 122 of the ego vehicle 102.

As indicated above the system 202 utilizes the perception sensors 112, 114, 116, 118, 120, and 122 of the ego vehicle 102 to detect one or more wheels of one or more surrounding object vehicles based on the data that is captured by the perception sensors. Referring to the wheel 402 of the object vehicle 104, the system 202 computes wheel movement information of the wheel 402. In various embodiments, the wheel information includes a variety of movement attribute information such as wheel rotation information. The system collects images and/or video footage of the wheel 402 to compute the rotation of the wheel 402. For example, the system 202 may analyze changes in the position of the particular features of the wheel 402 such as the spokes, lug nuts, and/or other shapes on the wheel. The system may also analyze changes in the position of the particular words, markings, treads or other features on the tire 404. By tracking the changes of such positions, the system 202 may compute rotation aspects of the wheel 402, including speed, acceleration, deceleration, etc.

In various embodiments, the wheel information may also include wheel direction information. For example, the system may track the shape of the wheel 402 and/or the shape of the tire 404 and determine when the wheel 402 changes direction. The system may also determine a vector direction based on the shapes of the wheel 402 and the tire 404.

In various embodiments, the system may also determine how much the wheel 402 is turning based on its position relative to the fender shape of the object vehicle 104. For example, the wheel 402 would appear differently in an image if the wheel 402 were turning to the right versus the wheel 402 traveling straight versus the wheel 402 turning to the left. In various embodiments, the system utilizes any suitable artificial intelligence (AI) model, including AI, machine learning, and computer vision techniques to track these changes and to determine the direction of the wheel 402 and the object vehicle 104.

In various embodiments, the system 202 tracks the distance between the wheel 402 of the object vehicle 104 and the lane between the object vehicle 104 and the ego vehicle 102. The system 202 also tracks the distance between the wheel 402 and the ego vehicle 102. As described in more detail herein, the system 202 also tracks changes to these distances over time in order to predict not only an impending collision but also to compute and predict an estimated collision time.

As indicated above, the wheel movement information that is computed by the system 202 indicates vehicle movement information of the object vehicle 104. For example, as indicated in example embodiments above, if the rotation of the wheel 402 is accelerating, the object vehicle 104 is also accelerating. If the wheel 402 is turning to the left, the object vehicle 104 is also turning to the left. If the distance between the wheel 402 and the lane between the object vehicle 104 and the ego vehicle 102, and/or the distance between the wheel 402 and the object vehicle 104 is decreasing, the distance between the object vehicle 104 and the ego vehicle 102 is also decreasing.

In various embodiments, the system 202 estimates distances of the object vehicle 104 from the ego vehicle 102 at different moments or instances based on the collected data associated with such wheel movement information. The system 202 utilizes the collected data to estimate the locations of the object vehicle 104 at different moments relative to the ego vehicle 102 in order to predict impending collisions between the object vehicle 104 and the ego vehicle 102. In various embodiments, the system utilizes any suitable AI model, including AI, machine learning, and computer vision techniques to predict such collisions. The system may also predict the time or moment of the collision based on the trajectory of the wheel 402 and the object vehicle 104 relative to the ego vehicle 102, which may be used to perform collision alerts or evasive actions.

In various embodiments, the system 202 calculates the time of impact of the object vehicle 104 and the ego vehicle 102 based on the estimated distance and the rate of change of the distance between the object vehicle 104 and the ego vehicle 102, and based on the relative speeds of the object vehicle 104 and the ego vehicle 102. In various embodiments, the system 202 may utilize Lidar techniques to estimate the distance between the object vehicle 104 and the ego vehicle 102. In some embodiments, the system may use AI and machine learning to determine the vehicle path of the both the ego vehicle 102 and the incoming object vehicle 104 based on the wheel movement information described herein.

In various embodiments, the system 202 alerts the driver of the ego vehicle 102 of the predicted collision based on the wheel information. Example embodiments directed to collision alerts and evasive actions are described in more detail below, in connection with FIGS. 5, 6, and 7, for example.

FIG. 5 is a flow chart for alerting the driver of an ego vehicle of a predicted collision. Referring to both FIGS. 1, 2, 3, and 5, a method is initiated at block 502, where a system such as the system 202 detects a predicted collision between the ego vehicle 102 and a surrounding object vehicle such as the object vehicle 104 based on wheel movement information. The system 202 detects the predicted collision between the vehicles in accordance with embodiments described herein.

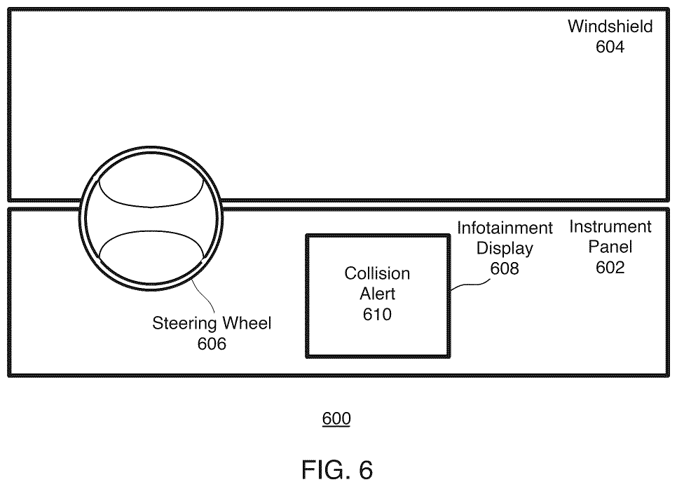

At block 504, the system 202 alerts the driver of the ego vehicle 102 of the predicted collision via the infotainment system of the ego vehicle. In various embodiments, the system 202 alerts the driver visually via an infotainment display of the infotainment system and/or auditory via speakers of the infotainment system. Example embodiments directed to the collision alerts and the infotainment system are described in more detail below, in connection with FIG. 6, for example.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 6 is a block diagram of an environment 600, showing a perspective toward the front of a vehicle, such as the ego vehicle 102 of FIGS. 1 and 2. Shown is a dashboard or instrument panel 602, a windshield 604, a steering wheel 606, and an infotainment display 608 of the infotainment system.

In various embodiments, when the system automatically alerts the driver of the ego vehicle 102 of a predicted collision, the system 202 may display a visual collision warning or collision alert 610 on the infotainment display 608. The following embodiments bring attention of predicted collisions to the driver of the ego vehicle 102 to aid the driver in avoiding such predicted collisions.

In various embodiments, the collision alert 610 may be any words indicating a warning that an impending collision between the ego vehicle 102 and another surrounding object vehicle. In some embodiments, the visual collision alert 610 may be accompanied by an audio alert that is delivered auditorily via the speaker system of the infotainment system.

In some embodiments, the visual collision alert 610 may be presented or rendered in a highly visual manner on the infotainment display to enhance visibility. For example, the collision alert 610 may include large letters (e.g., “COLLISION ALERT!”, “COLLISION WARNING!”, etc.). In some embodiments, the collision alert 610 may include information that is descriptive of the predicted collision (e.g., “COLLISION ALERT—ON RIGHT!”, etc.). In some embodiments, the infotainment display 608 may also display a map showing the object vehicle 104 approaching the ego vehicle 102 so that the ego driver is aware of the location of the object vehicle 104 to possibly avoid the predicted collision.

In some embodiments, the letters of the collision alert 610 may be presented in a predetermined eye-catching color coding (e.g., Red, etc.). In some embodiments, the letters of the collision alert 610 may encompass the entire infotainment display 608 so as to preclude other information from being displayed on the infotainment display 608. This increases the visibility of the collision alert 610. In some embodiments, the letters of the collision alert 610 may be animated (e.g., flashing letters, etc.). The actual characteristics of the collision alert 610 such as the wording, the font, the color, the animation, etc. may vary, depending on the particular implementation. Also, the presentation of any other helpful information for the driver may vary, depending on the particular implementation.

While various embodiments are described herein in the context of the collision alert 610 being displayed on the infotainment display 608, in some embodiments, the system 202 may also present the collision alert 610 and other related collision information on a heads up display (not shown) that the system 202 may present on the windshield 604 of the ego vehicle 102.

While various embodiments are described herein in the context of a predicted collision between the ego vehicle 102 and another surrounding object vehicles such as the object vehicle 104 and the object vehicle 106, these embodiments may also be applied to other potentially hazardous objects in the exterior environment. For example, the system 202 may detect potentially hazardous road obstacles such people, deer, construction equipment, boulders, ladders, etc. that are in the path and/or dangerously close to the path and/or approaching the path of the ego vehicle 102. A collision alert similar to those described herein may be displayed on the infotainment display 608.

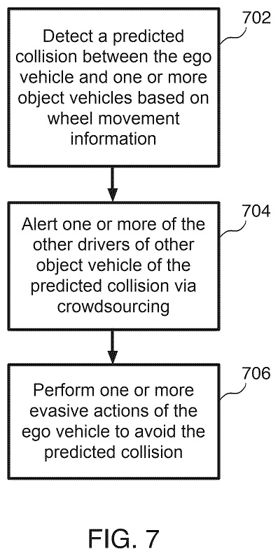

FIG. 7 is a flow chart for alerting drivers of surrounding object vehicles of a predicted collision and for performing evasive actions to avoid the vehicle collision. Referring to both FIGS. 1, 2, and 7, a method is initiated at block 702, where a system such as the system 202 detects a predicted collision between the ego vehicle 102 and one or more surrounding object vehicles such as the object vehicle 104 based on wheel movement information.

At block 704, the system 202 alerts one or more of the drivers of the other surrounding object vehicles of the predicted collision. For example, the system 202 may send an alert to the driver of the object vehicle 104 that is predicted to collide into the ego vehicle 102. The system 202 may also send alerts other drivers of surrounding object vehicles such as object vehicle 106 in the vicinity to help prevent those object vehicles from also getting involved in the predicted collision. In some embodiments, the system may automatically flash the hazard lights and/or sound the horn of the ego vehicle 102 in order to catch the attention of other drivers including pedestrians of the predicted collision. This enables others who notice such warnings to also avoid the predicted collision.

In various embodiments, the system 202 may identify and alert such surrounding object vehicles via crowdsourcing. For example, the system 202 may fetch crowdsourced data to facilitate the system 202 in identifying the surrounding object vehicles for sending alerts. Crowdsourced data may be vehicle-to-vehicle (V2V) data. The system 202 may also collect vehicle-to-infrastructure (V2I) data such as map data from the cloud and use global positioning system (GPS) technology to determine where the objects vehicles are located. In some embodiments, the system 202 may be configured to report the predicted collision to crowdsourcing applications.

At block 706, the system 202 performs one or more evasive actions to avoid the predicted collision. For example, in various embodiments, the system 202 may cause the ego vehicle 102 to automatically without driver intervention break to slow down or halt. The system 202 may also take control of the steering of the ego vehicle 102 to automatically steer the ego vehicle 102 in a safe escape path away from the object vehicle 104. The system 202 may determine an evasive maneuver without hitting or coming close to hitting other surrounding vehicles, pedestrians, obstacles, etc.). For example, before driving away from the object vehicle 104, the system 202 may first determine where there are no other object cars or other obstacles to the side of the ego vehicle 102 that the ego vehicle 102 may hit. The system 202 may then drive toward safe portions of the road in order to avoid the predicted collision.

In various embodiments, one of the evasive actions may include the system 202 alerting a traffic infrastructure system of the predicted collision. In some embodiments, the system 202 may communicate vehicle identifier information (e.g., license plate, VIN number, GPS location, etc.) associated with the ego vehicle 102 to the traffic infrastructure system, as well as vehicle identifier information associated with the incoming object vehicle. In response to the system 102 alerting the traffic infrastructure system of the predicted collision, the traffic infrastructure system may then collect vehicle identifier of other surrounding object vehicles. The traffic infrastructure system may also determine that the ego vehicle 102 and the incoming object vehicle 104 are approaching an intersection with a traffic signal. In response to that determination, the traffic infrastructure system may take one or more actions to prevent the predicted collision and to prevent any other potential subsequent or secondary collisions. For example, the traffic infrastructure system may cause the traffic signal to flash red in all directions. In some embodiments, the traffic infrastructure may alert other vehicles of the predicted collision. In some embodiments, the traffic infrastructure may alert the smart systems of any vehicles having any autonomous driving capabilities in order to enable such smart systems to take evasive actions to avoid the predicted collision.

These actions of the traffic infrastructure system may catch the attention of the driver of the ego vehicle 102, the driver of the object vehicle 104, and drivers of other surrounding vehicles traveling in the same direction and/or traveling toward the same intersection. This may in turn provide the driver of the ego vehicle 102 and the driver of the object vehicle 104 to avoid the predicted collision. This may also warn other drivers approaching the intersection and enable them to stay clear of the potentially dangerous intersection. The traffic infrastructure system may also cause the traffic signal to present a “Don't Walk” signal to pedestrians in all directions. This may catch the attention of pedestrians to stay clear of the potentially dangerous intersection.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

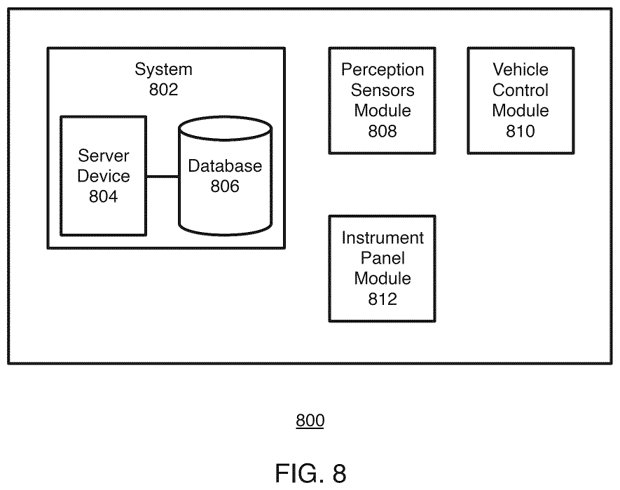

FIG. 8 is a block diagram of an example high-level architecture 800 for avoiding vehicle collisions. Shown is a system 802, which may be used to implement the system 202 of FIG. 3. The system 802 includes a server device 804 and a database 806. Also shown is a perception sensors module 808, a vehicle control module 810, and an instrument panel module 812. The perception sensors module 808, the vehicle control module 810, and the instrument panel module 812 may be implemented using a combination of hardware and software. In various embodiments, the software may include and execute any suitable AI model, including any AI, machine learning, and computer vision techniques to track wheel movement information and vehicle movement information of surrounding object vehicles, as well as to predict any impending collisions between the ego vehicle 102 and any surrounding object vehicles such as the object vehicle 104. The system may utilize the AI model to perform various evasive actions described herein.

The system 802 communicates data signals and control signals with the perception sensors module 808, the vehicle control module 810, and the instrument panel module 812 via the server device 804. The database 806 may be used to store various types of information such as wheel movement information and associated vehicle movement information, as well as AI training information, for example.

The system 802 enables the perception sensors module 808 to control and communicate data to and from the perception sensors of the ego vehicle 102 to detect and track wheels and other aspects of surrounding object vehicles. The system 802 also enables the vehicle control module 810 to autonomously control and communicate data to various systems of the ego vehicle 102 to perform a variety of evasive actions, as described herein. The system 802 also enables the instrument panel module 812 to control and communicate data and information to the infotainment system. For example, system 802 enables the instrument panel module 812 to control information displayed on the infotainment display to alert the driver of any predicted collisions.

Embodiments described herein have numerous benefits. For example, embodiments enable a system of an ego vehicle to detect and identify potential collisions between the ego vehicle and surrounding object vehicles traveling on the same street or road. Embodiments also provide alerts to the driver of the ego vehicle and to drivers of other surrounding object vehicles to aid in avoiding a predicted collision. Embodiments also enable the ego vehicle to perform one or more evasive actions to avoid the predicted collision.

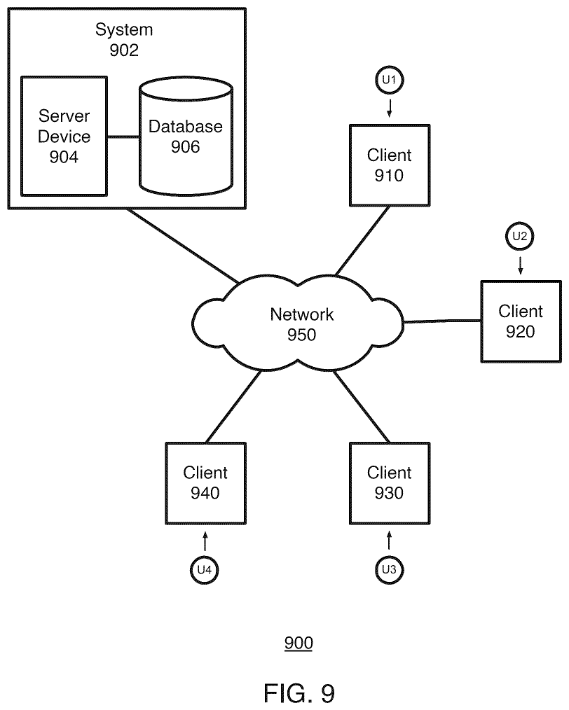

FIG. 9 is a block diagram of an example network environment 900 of the present disclosure. In some embodiments, network environment 900 includes a system 902, which includes a server device 904 and a database 906. In various embodiments, system 902 may be used to implement system 202 of FIG. 2 and/or system 802 of FIG. 8, as well as to perform embodiments described herein. Network environment 900 also includes client devices 910, 920, 930, and 940, which may communicate with system 902 and/or may communicate with each other directly or via system 902. The client devices 910, 920, 930, and 940 may be used to implement the perception sensors, the infotainment system, other systems associated with the ego vehicle, as well as any clients associated with surrounding object vehicles and/or clients associated with a traffic infrastructure system. Network environment 900 also includes a network 950 through which system 902 and client devices 910, 920, 930, and 940 communicate. Network 950 may be any suitable communication network such as a Wi-Fi network, Bluetooth network, the Internet, etc.

For ease of illustration, FIG. 9 shows one block for each of system 902, server device 904, and network database 906, and shows four blocks for client devices 910, 920, 930, and 940. Blocks 902, 904, and 906 may represent multiple systems, server devices, and network databases. Also, there may be any number of client devices. In other embodiments, environment 900 may not have all of the components shown and/or may have other elements including other types of elements instead of, or in addition to, those shown herein.

While server device 904 of system 902 performs embodiments described herein, in other embodiments, any suitable component or combination of components associated with system 902 or any suitable processor or processors associated with system 902 may facilitate performing the embodiments described herein.

In the various embodiments described herein, a processor of system 902 and/or a processor of any client device 910, 920, 930, and 940 cause the elements described herein (e.g., information, etc.) to be displayed in a user interface on one or more display screens.

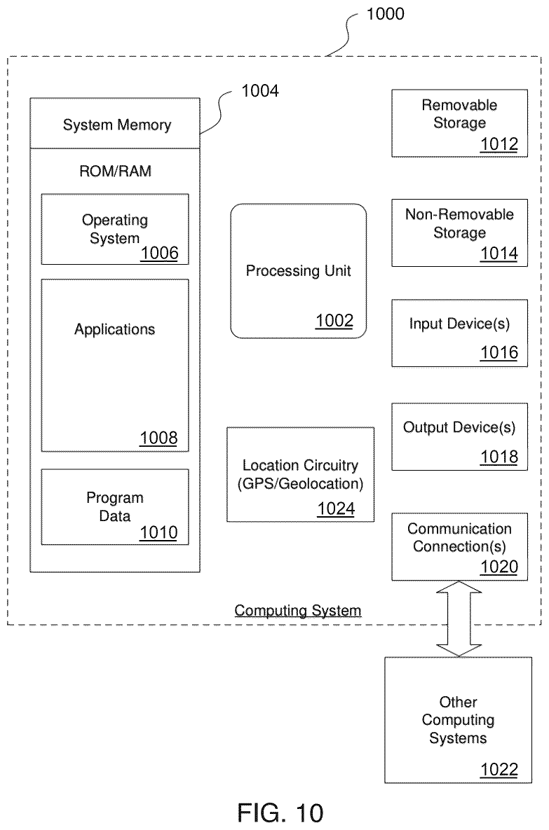

FIG. 10 is a block diagram of an example computing system 1000 of the present disclosure. The computing system 1000 may be used to implement the system 202 of FIG. 2 and/or system 802 of FIG. 8 and/or system 902 of FIG. 9, as well as to perform embodiments described herein.

The computing system 1000 typically includes at least one processing unit 1002 and a system memory 1004. Depending on the particular configuration and type of computing device, the system memory 1004 may be volatile such as random-access memory (RAM), non-volatile such as read-only memory (ROM), flash memory, and the like, or some combination of volatile memory and non-volatile memory. The system memory 1004 typically maintains an operating system 1006, one or more applications 1008, and program data 1010. The operating system 1006 may include any number of operating systems executable on desktops or portable devices including, but not limited to, Linux, Microsoft Windows®, Apple OS®, or Android®.

The computing system 1000 may also have additional features or functionality. For example, the computing system 1000 may also include additional data storage devices (removable and/or non-removable) such as, for example, magnetic disks, optical disks, tape, or flash memory. Such additional storage may include removable storage 1012 and non-removable storage 1014. Computer storage media may include volatile and non-volatile, removable and non-removable media implemented in any method or technology for storage of information, such as computer-readable instructions, data structures, program modules or other data. The system memory 1004, the removable storage 1012, and the non-removable storage 1014 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 1000. Any such computer storage media may be part of the computing system 1000.

The computing system 1000 may also have input device(s) 1016 such as a keyboard, mouse, pen, voice input device, touchscreen input device, etc. Output device(s) 1018 such as a display, speakers, printer, short-range transceivers such as a Bluetooth transceiver, etc., may also be included. The computing system 1000 also may include one or more communication connections 1020 that allow the computing system 1000 to communicate with other computing systems 1022, such as over a wired or wireless network or via Bluetooth (a Bluetooth transceiver may be regarded as an input/output device and a communications connection). The one or more communication connections 1020 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 1000 may also include location circuitry 1024. In various embodiments, the location circuitry 1024 may include circuitry including global positioning system (GPS) circuitry and/or geolocation circuitry. The location circuitry 1024 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 1024, including GPS circuitry and/or geolocation circuitry, is frequently incorporated in smartphones and many other tablets or other portable devices. In various embodiments, computing system 1000 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. An ego vehicle comprising:
at least one perception sensor coupled to the ego vehicle; and
a system comprising one or more processors and logic encoded in one or more non- transitory computer-readable storage media for execution by the one or more processors and when executed operable to cause the one or more processors to perform operations comprising:
capturing data on an external environment using the at least one perception sensor;
detecting at least one wheel of at least one object vehicle based on the data that is captured;
computing wheel movement information of the at least one wheel, wherein the wheel movement information indicates vehicle movement information of the at least one object vehicle; and
detecting a predicted collision between the ego vehicle and the at least one object vehicle based on the wheel movement information.

2. The ego vehicle of claim 1, wherein the wheel information comprises wheel rotation information.

3. The ego vehicle of claim 1, wherein the logic when executed is further operable to cause the one or more processors to perform operations comprising alerting a driver of the ego vehicle of the predicted collision based on the wheel information.

4. The ego vehicle of claim 1, wherein the logic when executed is further operable to cause the one or more processors to perform operations comprising alerting a driver of the ego vehicle of the predicted collision via an infotainment system of the ego vehicle.

5. The ego vehicle of claim 1, wherein the logic when executed is further operable to cause the one or more processors to perform operations comprising alerting at least one other driver of the at least one object vehicle of the predicted collision via crowdsourcing.

6. The ego vehicle of claim 1, wherein the logic when executed is further operable to cause the one or more processors to perform operations comprising performing one or more evasive actions of the ego vehicle to avoid the predicted collision.

7. The ego vehicle of claim 1, wherein the logic when executed is further operable to cause the one or more processors to perform operations comprising performing one or more evasive actions to avoid the predicted collision, and wherein at least one evasive action of the one or more evasive actions comprises alerting a traffic infrastructure system of the predicted collision.

8. A non-transitory computer-readable storage medium with program instructions stored thereon, the program instructions when executed by one or more processors are operable to cause the one or more processors to perform operations comprising:
capturing data on an external environment using at least one perception sensor coupled to an ego vehicle;
detecting at least one wheel of at least one object vehicle based on the data that is captured;
computing wheel movement information of the at least one wheel, wherein the wheel movement information indicates vehicle movement information of the at least one object vehicle; and
detecting a predicted collision between the ego vehicle and the at least one object vehicle based on the wheel movement information.

9. The computer-readable storage medium of claim 8, wherein the wheel information comprises wheel rotation information.

10. The computer-readable storage medium of claim 8, wherein the instructions when executed are further operable to cause the one or more processors to perform operations comprising alerting a driver of the ego vehicle of the predicted collision based on the wheel information.

11. The computer-readable storage medium of claim 8, wherein the instructions when executed are further operable to cause the one or more processors to perform operations comprising alerting a driver of the ego vehicle of the predicted collision via an infotainment system of the ego vehicle.

12. The computer-readable storage medium of claim 8, wherein the instructions when executed are further operable to cause the one or more processors to perform operations comprising alerting at least one other driver of the at least one object vehicle of the predicted collision via crowdsourcing.

13. The computer-readable storage medium of claim 8, wherein the instructions when executed are further operable to cause the one or more processors to perform operations comprising performing one or more evasive actions of the ego vehicle to avoid the predicted collision.

14. The computer-readable storage medium of claim 8, wherein the instructions when executed are further operable to cause the one or more processors to perform operations comprising performing one or more evasive actions to avoid the predicted collision, and wherein at least one evasive action of the one or more evasive actions comprises alerting a traffic infrastructure system of the predicted collision.

15. A computer-implemented method for avoiding vehicle collisions, the method comprising:
capturing data on an external environment using at least one perception sensor coupled to an ego vehicle;
detecting at least one wheel of at least one object vehicle based on the data that is captured;
computing wheel movement information of the at least one wheel, wherein the wheel movement information indicates vehicle movement information of the at least one object vehicle; and
detecting a predicted collision between the ego vehicle and the at least one object vehicle based on the wheel movement information.

16. The method of claim 15, wherein the wheel information comprises wheel rotation information.

17. The method of claim 15, further comprising alerting a driver of the ego vehicle of the predicted collision based on the wheel information.

18. The method of claim 15, further comprising alerting a driver of the ego vehicle of the predicted collision via an infotainment system of the ego vehicle.

19. The method of claim 15, further comprising alerting at least one other driver of the at least one object vehicle of the predicted collision via crowdsourcing.

20. The method of claim 15, further comprising performing one or more evasive actions of the ego vehicle to avoid the predicted collision.
